(19) United States
(12) Patent Application Publication
(10) Pub. No.: US 2026/0338580 A1
(43) Pub. Date: Oct. 29, 2026

(54) UPDATING A MAP FOR SIMULTANEOUS LOCALISATION AND MAPPING

(71) Applicant: Telefonaktiebolaget LM Ericsson (publ), Stockholm (SE)

(72) Inventors: Roberto CASTRO SUNDIN, Tullinge (SE); David UMSONST, Solna (SE); José ARAÚJO, Stockholm (SE); Magnus LINDHÉ, Sundbyberg (SE); Alejandra HERNANDEZ SILVA, Solna (SE); Paula CARBÓ CUBERO, Spånga (SE); André MATEUS, Solna (SE); Fernando dos Santos BARBOSA, Tullinge (SE)

(73) Assignee: Telefonaktiebolaget LM Ericsson (publ), Stockholm (SE)

(21) Appl. No.: 19/123,198

(22) PCT Filed: Oct. 24, 2022
(86) PCT No.: PCT/EP2022/079513

§ 371 Date: Apr. 22, 2025

(51) Int. Cl. G01C 21/00

(52) U.S. Cl. CPC G01C 21/3859; G01C 21/383; G01C 21/3837; G01C 21/3896

(57) ABSTRACT

It is provided a method for updating a map for SLAM. The method being performed by a system comprising mobile device, comprising a sensor, and a server. The method comprises: collecting measurements from the at least one sensor; updating a local map, wherein the local map is in the form of a graph; determining based on a duration of performing the updating of the local map, that a reduced local map is to be requested; sending to the server, a request for a reduced local map; receiving from the mobile device, the request for a reduced local map; determining a reduced local map for the mobile device being a subset of a global map, wherein the global map is in the form of a graph comprising vertices and edges; sending to the mobile device, the determined reduced local map; and receiving, from the server, the reduced local map.

### TECHNICAL FIELD

The present disclosure relates to the field of simultaneous localisation and mapping (SLAM), and in particular to updating a map for SLAM.

### BACKGROUND

Localisation and mapping are used for many types of mobile devices, such as for extended reality (XR) devices, encompassing augmented reality (AR) and virtual reality (VR) devices, as well as self-driving cars, unmanned aerial vehicles, robots, etc. Localisation is the process of determining the pose of a device/object in space, where pose is defined as the concatenation of position and orientation. Mapping is the process of mapping the real world in a data structure.

Performance of localisation and mapping for mobile devices can be enhanced by merging structural (visual and/or depth-related) information from electronic environment sensors e.g. cameras, lidar, etc., and motion information from Inertial Measurement Units (IMUs). In this way, the mobile device is able to acquire six degrees of freedom movements of the mobile device (rotation and translation).

The localisation is based on a map comprising representations of the physical space. The representation can be the result of processing of the raw structural data from one or more mobile devices, each comprising one or more environment sensors. The representation can e.g. comprise segments representing sections of the physical space and/or features representing distinguishable geometric structures in the physical space. The localisation is performed when captured data from the environment sensor(s) is processed and compared with the data in the map. When a match is found, this results in a pose of the mobile device being determined. When it is correctly determined that the mobile device has returned to a previously visited location, this is known as loop closure.

When both localisation and mapping are combined, i.e. learning an area while keeping track of a pose of a mobile device, this is known as Localisation and Mapping (LM), or Simultaneous Localisation and Mapping (SLAM).

Modern SLAM systems often comprise of two interconnected parts, a front-end and a back-end. The front-end processes the measurements taken from the environment. This processing can comprise a feature extraction module, which extracts relevant features from the environment measurements, and a data association module, which brings the measurements in relationship to each other. The back-end uses the processed measurements to perform inference via maximum a posteriori (MAP) estimation. The current state-of-the-art to perform the MAP estimation is a graph-SLAM approach, where the map is abstracted into a mathematical graph. Therefore, the terms map and graph are interchangeable in this document.

One component in SLAM is the construction and repetitive update of the map. A relevant challenge arises from the fact that mobile devices can often be resource-constrained embedded devices, which reduces the extent of processing that can be performed for the localisation and/or the map processing.

### SUMMARY

One object is to make updates to a local map in a mobile device more efficient.

According to a first aspect, it is provided 1. A method for updating a map for simultaneous localisation and mapping, SLAM, the method being performed by a system comprising mobile device comprising at least one sensor and a server. The method comprises: collecting, by the mobile device, measurements from the at least one sensor; updating, by the mobile device, a local map based on the measurements, wherein the local map is in the form of a graph comprising vertices and edges; determining, by the mobile device, based on a duration of performing the updating of the local map, that a reduced local map is to be requested; sending, by the mobile device, to the server, a request for a reduced local map; receiving, by the server, from the mobile device, the request for a reduced local map; determining, by the server, a reduced local map for the mobile device being a subset of a global map, wherein the global map is in the form of a graph comprising vertices and edges; sending, by the server, to the mobile device, the determined reduced local map; and receiving, by the mobile device, from the server, the reduced local map.

According to a second aspect, it is provided a method for updating a map for simultaneous localisation and mapping, SLAM, the method being performed by a mobile device comprising at least one sensor. The method comprises: collecting measurements from the at least one sensor; updating a local map based on the measurements, wherein the local map is in the form of a graph comprising vertices and edges; determining, based on a duration of performing the updating of the local map, that a reduced local map is to be requested; sending, to a server, a request for a reduced local map; and receiving, from the server, a reduced local map.

The determining that the reduced local map is to be requested may comprise calculating a duration statistic based on the most recent duration, as well as previously determined durations, of performing the updating of the local map, and determining that the duration statistic is greater than a threshold.

The duration statistic may be based on at least one of a moving average filter, and a moving median filter.

The method may further comprise: merging the reduced local map with at least one measurement collected after the sending the request to the server.

The measurements may be based on at least one of inertial measurements, LIDAR measurements, two-dimensional images, three-dimensional images and radar measurements.

Each vertex may represent a pose or a feature.

According to a third aspect, it is provided a mobile device for updating a map for simultaneous localisation and mapping, SLAM. The mobile device comprises: at least one sensor; a processor; and a memory storing instructions that, when executed by the processor, cause the mobile device to: collect measurements from the at least one sensor; update a local map based on the measurements, wherein the local map is in the form of a graph comprising vertices and edges; determine, based on a duration of performing the updating of the local map, that a reduced local map is to be requested; send, to a server, a request for a reduced local map; and receive, from the server, a reduced local map.

The instructions to determine that the reduced local map is to be requested may comprise instructions that, when executed by the processor, cause the mobile device to calculate a duration statistic based on the most recent duration, as well as previously determined durations, of performing the updating of the local map, and determining that the duration statistic is greater than a threshold.

The duration statistic may be based on at least one of a moving average filter, and a moving median filter.

The mobile device may further comprise instructions that, when executed by the processor, cause the mobile device to merge the reduced local map with at least one measurement collected after the instructions to send the request to the server are performed.

The measurements may be based on at least one of inertial measurements, LIDAR measurements, two-dimensional images, three-dimensional images and radar measurements.

Each vertex may represent a pose or a feature.

According to a fourth aspect, it is provided a computer program for updating a map for simultaneous localisation and mapping, SLAM. The computer program comprises computer program code which, when executed on a mobile device causes the mobile device to: collect measurements from the at least one sensor; update a local map based on the measurements, wherein the local map is in the form of a graph comprising vertices and edges; determine, based on a duration of performing the updating of the local map, that a reduced local map is to be requested; send, to a server, a request for a reduced local map; and receive, from the server, a reduced local map.

According to a fifth aspect, it is provided a computer program product comprising a computer program according to the fourth aspect and a computer readable means comprising non-transitory memory in which the computer program is stored.

According to a sixth aspect, it is provided a method for updating a map for simultaneous localisation and mapping, SLAM, the method being performed by a server. The method comprises: receiving, from a mobile device, a request for a reduced local map; determining a reduced local map for the mobile device being a subset of a global map, wherein both the global map and the reduced local map are in the form of a graph comprising vertices and edges; and sending, to the mobile device, the determined reduced local map.

The method may further comprise: determining a request time interval between consecutively received requests for a reduced local map, in which case the determining the reduced local map for the mobile device is also based on the request time interval.

The determining a request time interval may comprise calculating a time interval statistic based on the most recent request time interval as well as at least one previously determined request time interval.

The determining a reduced local map may comprise determining a reduced local map that is smaller than a previous reduced local map when the time interval statistic is smaller than a first threshold.

The determining a reduced local map may comprise determining a reduced local map that is larger than a previous reduced local map when the time interval statistic is greater than a second threshold.

The method may further comprise, prior to the determining a reduced local map: determining a plurality of candidate local maps, in which case the determining the reduced local map for the mobile device comprises selecting a map, from the plurality of candidate local maps, that is the sparsest candidate local map.

In one embodiment, the determining a plurality of candidate local maps is only performed if a resource utilisation of the server is less than a utilisation threshold.

Each vertex represents a pose or a feature.

According to a seventh aspect, it is provided a server for updating a map for simultaneous localisation and mapping, SLAM. The server comprises: a processor; and a memory storing instructions that, when executed by the processor, cause the server to: receive, from a mobile device, a request for a reduced local map; determine a reduced local map for the mobile device being a subset of a global map, wherein both the global map and the reduced local map are in the form of a graph comprising vertices and edges; and send, to the mobile device, the determined reduced local map.

The server may further comprise instructions that, when executed by the processor, cause the server to: determine a request time interval between consecutively received requests for a reduced local map, in which case the instructions to determine the reduced local map for the mobile device comprises instructions that, when executed by the processor, cause the server to determine the reduced local map also based on the request time interval.

The instructions to determine a request time interval may comprise instructions that, when executed by the processor, cause the server to calculate a time interval statistic based on the most recent request time interval as well as at least one previously determined request time interval.

The instructions to determine a reduced local map may comprise instructions that, when executed by the processor, cause the server to determine a reduced local map that is smaller than a previous reduced local map when the time interval statistic is smaller than a first threshold.

The instructions to determine a reduced local map may comprise instructions that, when executed by the processor, cause the server to determine a reduced local map that is larger than a previous reduced local map when the time interval statistic is greater than a second threshold.

The server may further comprise instructions that, when executed by the processor, cause the server to execute, prior to the instructions to determine a reduced local map: determine a plurality of candidate local maps, in which case the instructions to determine the reduced local map for the mobile device comprises instructions that, when executed by the processor, cause the server to select a map, from the plurality of candidate local maps, that is the sparsest candidate local map.

In one embodiment, the server further comprises instructions that, when executed by the processor, cause the server to execute the instructions to determine a plurality of candidate local maps is only if a resource utilisation of the server is less than a utilisation threshold.

Each vertex may represent a pose or a feature.

According to an eighth aspect, it is provided a computer program for updating a map for simultaneous localisation and mapping, SLAM. The computer program comprises computer program code which, when executed on a server causes the server to: receive, from a mobile device, a request for a reduced local map; determine a reduced local map for the mobile device being a subset of a global map, wherein both the global map and the reduced local map are in the form of a graph comprising vertices and edges; and send, to the mobile device, the determined reduced local map.

According to a ninth aspect, it is provided a computer program product comprising a computer program according to the eighth and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIG. 2 is a schematic diagram illustrating a system for updating a map for SLAM;

FIGS. 3A-B are swimlane diagrams illustrating embodiments of methods for updating a map for SLAM;

FIG. 4 is a schematic diagram illustrating components of the mobile device and the server of FIG. 1 and FIG. 2 according to one embodiment;

FIG. 5 is a schematic diagram showing functional modules of the mobile device of FIG. 1 according to one embodiment;

FIG. 6 is a schematic diagram showing functional modules of the server of FIG. 1 according to one embodiment; and

FIG. 7 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, an improved management of local maps in mobile devices are achieved, where there is a local map in the mobile device and a global map in a server. The computational load is reduced in the mobile device for graph optimization and network load is reduced. An event-triggered mechanism monitors the mobile device execution time of the graph optimization and the mobile device sends a request for a reduced map to the server once a statistic (e.g., arithmetic mean, median, min/max) of the execution time has grown larger than a threshold. Furthermore, in one optional embodiment, the server does not simply calculate a fixed reduced map but utilizes its computation power to calculate several reduced maps and then selects the sparsest reduced map among several reduced maps. Moreover, in one optional embodiment, the server determines a statistic on the time between requests from the mobile device, to thereby infer the computational load on the mobile device, where a shorter time between requests means that the device struggles to solve the graph optimization even when the server provides a reduced map of a certain size. Based on this inference, the server can adjust the size of the reduced map, where a smaller size usually results in shorter execution time on the mobile device, or the server takes over the graph optimization completely if the size of the reduced map becomes too small.

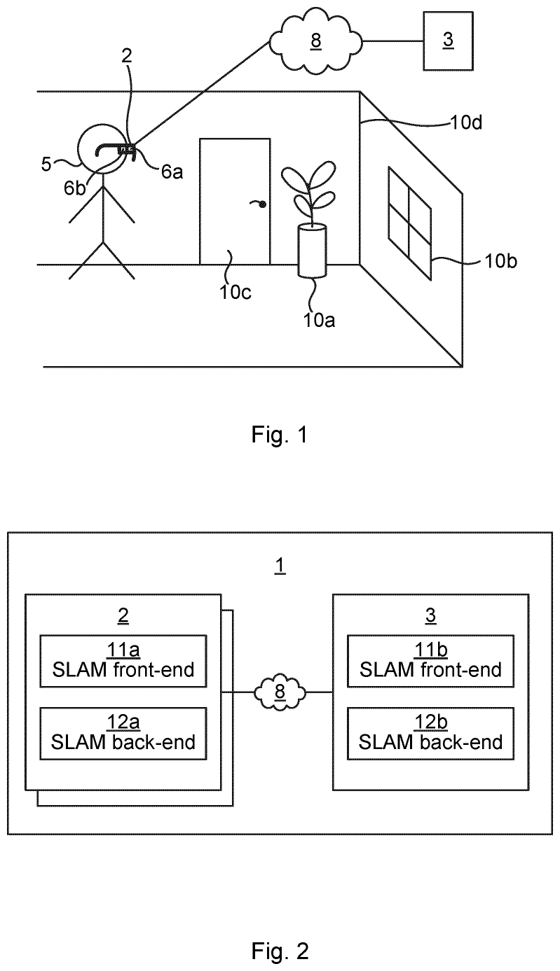

FIG. 1 is a schematic diagram illustrating an environment in which embodiments presented herein can be applied. In the example illustrated in FIG. 1, there is a user 5 with a mobile device 2. The mobile device 2 comprises at least one sensor. In this example, there is a first sensor 6a in the form of a camera and a second sensor 6b in the form of an Inertial Measurement Unit (IMU). The IMU can e.g. comprise an accelerometer and a gyro. Other examples of possible sensors are a LIDAR sensor, a radar sensor, stereo camera, structure from motion, etc. The mobile device 2 can be a wearable device, such as smart glasses, head-mounted display (HMD), or the mobile device 2 can be a smartphone, car, etc. The mobile device 2 can also be provided as a device that does not require user interaction, e.g. in the form of a self-driving vehicle or robot.

One or more servers 3 are provided with ability to communicate with the mobile device 2, as well as other mobile devices (not shown). The communication occurs over a communication network 8, e.g. based on Internet Protocol traffic over any one or more wireless or wired-based technology, such as a cellular network, any of the IEEE 802.11x standards (also known as Wi-Fi), using Bluetooth or Bluetooth Low Energy (BLE), ZigBee, Ethernet, optical communication, etc. The cellular communication network can e.g. comply with any one or a combination of sixth generation (6G) networks, next generation (NG) mobile networks (fifth generation, 5G), LTE (Long Term Evolution), UMTS (Universal Mobile Telecommunications System) utilising W-CDMA (Wideband Code Division Multiplex), CDMA2000 (Code Division Multiple Access 2000), or any other currently known or future wireless network, as long as the principles described hereinafter are applicable.

The server 3 can be implemented as a so-called edge server, implying that it is topologically close to the mobile device 2, which reduces latency and increases responsiveness. Alternatively, the server 3 is implemented in a more central location topologically, which allows the server 3 to serve a larger number of mobile devices 2 in different areas.

Collectively, the server 3 and one or more mobile devices 2 form a system, that is used for updating a local map for use by mobile device 2, according to procedures that are described in more detail below.

In the environment around the user 5, there are a number of visual features 10a-d, e.g. a first visual feature 10a in the form of a plant, a second visual feature 10b in the form of a window, a third visual feature 10c in the form of a door and a fourth visual feature 10d in the form of a corner in the room. There may be many more (or fewer) visual features depending on the location of the user 5 and feature detection capabilities of the mobile device 2.

The mobile device 2 is capable of performing localisation as well as mapping using its sensor based on SLAM. By performing localisation and mapping, the mobile device is able to calculate its pose with respect to the physical space. Pose is a term that, in the present context, includes both position and orientation.

The mobile device 2 stores a local map. Map processing performed in the mobile device 2 results in updates to the local map.

The server 3 stores a global map, also sometimes referred to as a central map. It is to be noted that the global map is global only within the particular implementation. In other words, for multiple implementations or systems, there are respective global maps. Hence, there is not only one global map in the world; there are multiple global maps. Since the server 3 is less restricted in terms of processing power and storage, the global map can be significantly larger than the local map. The local map can be based on a subset of the global map, covering an area or a set of features covered by the global map. Hence, the global map on the server is richer than the local map, unless the mobile device is in an area not yet covered by the global map, in which case the local map and the global map can, at least initially, develop synchronously.

Hence, the local map is a map which can contain information related to the immediate vicinity of the mobile device. A global map is a map which is an aggregation of all measurements taken by one or more mobile devices. The global map thus comprises information related to an environment which can be acquired over a longer period of time and can also contain local maps acquired by more than one mobile device 2 and for multiple different physical locations. For example, if the device is used in a building, then the global map could have information about the whole building. The global map could contain the different floor plans with the rooms that the mobile device has already explored. In this example, the local map would have only information of one of the floors in the building or even only a section or a room where the mobile device is currently located. With reference to FIG. 1, what is visible in FIG. 1 is the local map, while the part of the room/house that is not visible, e.g. the part to the left of the user 5 or on the other side of the door 10c, is in the global map.

FIG. 2 is a schematic diagram illustrating a system 1 for updating a map for SLAM. The system 1 comprises a server 3 and at least one mobile device 2.

As explained above, modern SLAM systems can comprise of two interconnected parts, a front-end and a back-end. The mobile device(s) 2 comprises a mobile SLAM front-end 11a and a mobile SLAM back-end 12a. The server 3 comprises a server SLAM front-end 11b and a server SLAM back-end 12b.

Similar processing occurs in both front-ends 11a, 11b and similar processing occurs in both back-ends 12a, 12b. The processing will herein only be distinguished between mobile device 2 and server 3 where this makes a difference. The front-end 11a, 11b processes the measurements taken from the environment. This processing can comprise a feature extraction module, which extract relevant features from the environment measurements, and a data association module, which brings the measurements in relationship to each other. These relationships can be translated into relative translations and rotations of the device. The back-end 12a, 12b uses the processed measurements to perform inference via maximum a posteriori estimation.

In the back-end 12a, 12b, the processed measurements are used to create a graph where each vertex in the graph represents a feature-based landmark observed in the environment, or a pose of the device. An edge between vertices in the graph encodes how the vertices relate to each other, e.g. how to far a certain landmark is from a certain pose. The data association module in the front-end 11a, 11b can be responsible for creating the edges between the vertices in the graph.

The graph reflects loop closures that have been added to the graph as edges between (possibly non-consecutive) vertices, in which case non-consecutive vertices of the graph are connected with an edge. This implies the device is currently in a location in its environment that it has visited before and, therefore, recognizes. Loop-closures help mitigate the effect of accumulated errors in the sensor-based odometry (sensors such as LiDAR, IMU, Visual-Inertial). In order to detect loop-closures, the device needs access to previous measurements. Hence, the greater area that a device explores, the more data it gathers, such that the limitations of a resource-constrained mobile device 2 can be reached quickly, especially for lightweight devices, such as AR glasses. In the following, the focus is on the back-end 12a, 12b of the SLAM algorithm since the front-end 11a, 11b varies significantly dependent on the sensors used on the mobile device 2.

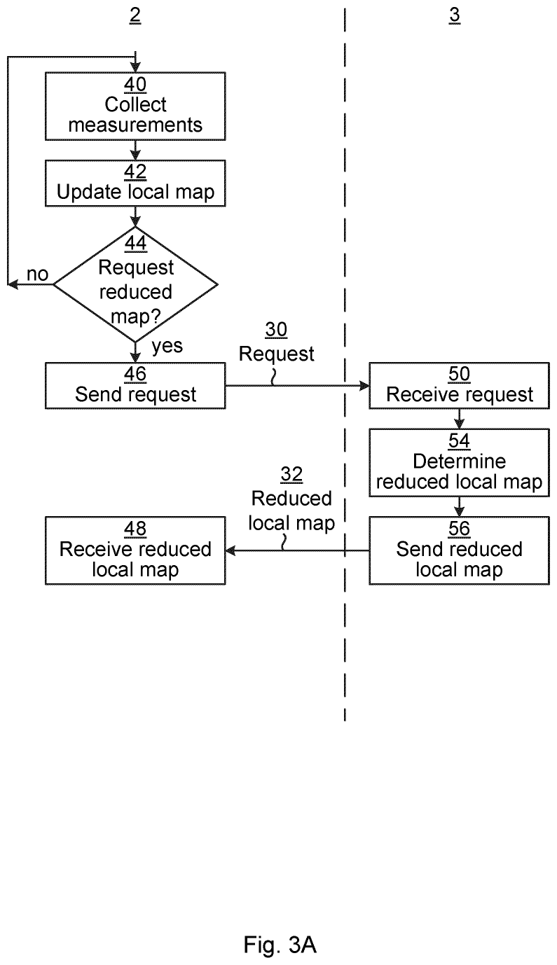

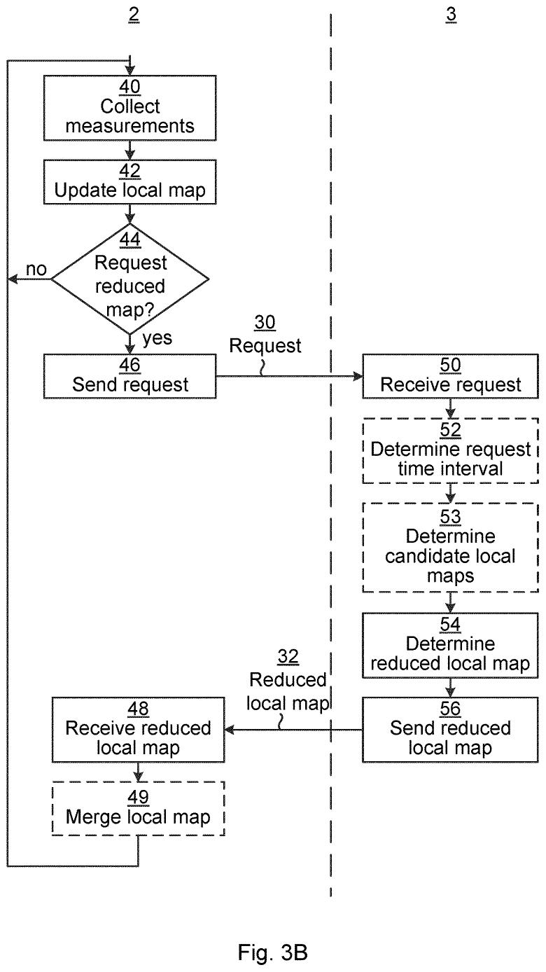

FIGS. 3A-B are swimlane diagrams illustrating embodiments of methods for updating a map for SLAM. The swimlane diagrams can be considered to comprise a flow chart for methods in the mobile device 2 on the left and a flow chart for methods in the server 3 on the right. Communication between the mobile device 2 and the server 3 is also shown. On an overview level, the mobile device 2 observing the environment utilizes the server 3 to request a reduced local map of the environment from the server 3. This is done to save computational resources on the mobile device 2 in the form of execution time of the mobile SLAM back-end 12a. First, the swimlane diagram of FIG. 3A will be described.

In a collect measurements step 40, the mobile device 2 collects measurements from the at least one sensor 6a-b. The measurements can be e.g. based on at least one of inertial measurements (e.g. using an IMU), LIDAR measurements, two-dimensional images, three-dimensional images and radar measurements. Hence, the mobile device runs a SLAM algorithm and observes the environment by taking sensor measurements. The measurements and SLAM enable the mobile device to orient itself in its environment and create a map of the environment. The mobile device also sends the measurements, possibly pre-processed by the mobile SLAM front-end 11a to the server 3.

In an update local map step 42, the mobile device 2 updates a local map based on the measurements, wherein the local map is in the form of a graph comprising vertices and edges. Each vertex may represent a pose or a feature. Each edge between vertices then represents the relation (e.g. representing physical distance) between the two vertices.

The processed measurements are incorporated into the local map, [symbol] , in the mobile SLAM back-end 12a and in the global map, [symbol] , in the server SLAM back-end 12b after more processing in the server SLAM front-end 11b. When the mobile device takes a measurement at time step k and adds it to its own map, the size of the map increases. Here, each measurement is considered to add at least one new vertex to the graph representing [symbol] such that the number of vertices increases by at least one, i.e., N_{L}(k)≥N_{L}(k−1)+1. Similarly, the measurement is also added to the map on the server such that the number of vertices in [symbol] also increases, i.e., N_{G}(k)≥N_{G}(k−1)+1. The mobile SLAM front-end 11a will, however, not have access to all previous measurements such that it cannot reliably detect loop-closures in its mobile SLAM front-end 11a. Hence, the increase in the number of edges in [symbol] will always be less than, or equal to, the increase in the number of servers in the server's graph [symbol] , because the server has access to all measurements and can therefore perform loop-closure detection in its server SLAM front-end 11b.

The more measurements the mobile device takes, the more the local map grows, i.e. the number of vertices of the graph representing the map increases. Therefore, the execution time of the graph optimization (GO) in the mobile SLAM back-end 12a, which the mobile device runs to both built a map of the environment and orient itself in the environment, increases as well. The graph optimization can be expressed in the form of a matrix equation. Thereafter, nonlinear least squares algorithms can be used to perform the optimization. There is a relationship between the number of vertices, N_{L}(k), in the local map and the execution time, Tₑ(k), of the GO, that is, Tₑ(k)=f(N_{L}(k),O), where f(⋅) can be an unknown function. Here, O represents other variables that influence the execution time such as the mobile device's computational resources, the current computational load of the mobile device, and/or the sparsity of the graph representing [symbol] .

In a conditional request reduced map step 44, the mobile device 2 determines, based on a duration of performing the updating of the local map, when a reduced local map 32 is to be requested. Since the execution time of the GO can scale, in the worst-case, cubically with N_{L}(k), the mobile device sends a request to the server to compute a reduced map once the execution time has grown too large. The sparser the graph, the faster the optimization, while a fully dense graph would scale the execution time of the GO cubically in N_{L}(k).

The determination of when the reduced local map is to be requested can comprise calculating a duration statistic based on the most recent duration, as well as previously determined durations, of performing the updating of the local map (i.e. GO). The duration statistic can be based on at least one of a moving average filter, and a moving median filter.

More specifically, the execution time for GO can fluctuate due to other processes running on the mobile device. To handle the fluctuations, the mobile device determines a statistic T̅ₑ(k) over the last l execution times for GO, that is, T̅ₑ(k)=g(Tₑ(k), Tₑ(k−1), . . . , Tₑ(k−l+1)), where g(⋅) is a function determining the statistic, Tₑ(i) is the GO execution time at the ith execution and k is the time index of the current execution.

In one embodiment, the statistic is a moving average filter,

$${\overline{T}}_{e} ( k ) = \frac{1}{l} {\sum }_{i = k - l + 1}^{k} {T}_{e} ( i ) ,$$

where Tₑ(i)=0 if i<0. This embodiment has an effect of easy calculation.

In one embodiment, the statistic is a moving median filter

$${\overline{T}}_{e} ( k ) = Median ( {T}_{e} ( k - l + 1 ) , {T}_{e} ( k - l + 2 ) , … , {T}_{e} ( k - 1 ) , {T}_{e} ( k ) ) ,$$

where Tₑ(i)=0 if i<0 and Median(⋅) calculates the median value of the inputs. This embodiment is more robust to outliers in the execution time Tₑ(i) compared to the preceding embodiment.

In a one embodiment, the statistic is

$${\overline{T}}_{e} ( k ) = \frac{1}{l} {\sum }_{i = k - l + 1}^{k} {T}_{e} ( i ) ,$$

if k<l and

$${\overline{T}}_{e} ( k ) = Median ( {T}_{e} ( k - l + 1 ) , {T}_{e} ( k - l + 2 ) , … , {T}_{e} ( k - 1 ) , {T}_{e} ( k ) ) ,$$

if k≥l.

This embodiment has the effect compared to the preceding embodiment that it will return a non-zero number when

$$k \leq ⌊ \frac{l}{2} ⌋ ,$$

since the output of the moving median filter will be skewed by the zero values coming from the filter's initialization.

Next, let T_{e,max} be the threshold for the execution time that T̅ₑ(k) should not exceed. When the duration statistic is greater than the threshold T_{e,max}, this indicates that the local map is growing too large, whereby the mobile device determines that a reduced map is to be requested. In one embodiment, the duration statistic does not exceed a value that is in the order of 0.1 s, but the exact value of T_{e,max} will be application specific. When a reduced local map is to be requested, the method proceeds to a send request step 46. Otherwise, the method returns to the collect measurements step 40.

In the send request step 46, the mobile device 2 sends (to the server 3) a request 30 for a reduced local map. In one embodiment, the size of the reduced local map to be provided has been predetermined to be of a maximum size of N_{L,red}. Here, N_{L,red} is a fixed map size that has been determined offline and has been shown to lead to an execution time of the GO below a desired value T_{e,ref}<T_{e,max} under benign conditions for the mobile device. Therefore, using the reduced map and adding new measurements to it will lower the statistic of the execution time below T_{e,max}.

In a receive request step 50, the server receives (from the mobile device 2) the request 30 for a reduced local map. On the server side, we will denote the request times with time index j, which is different from the time index of the execution of the GO, k.

In a determine reduced local map step 54, the server 3 determines a reduced local map 32 for the mobile device 2 being a subset of a global map, that the server 3 has access to. Also the global map is in the form of a graph comprising vertices and edges.

To compute the reduced map the server needs its global map, [symbol] , which is based on all measurements taken by the mobile device(s) and have been transmitted to the server. Additional information can be obtained by the server to compute the reduced map in more sophisticated ways, which, for example, also takes the CPU load of the server into account. There are thus different embodiments of map determination for information gathering in the server. The first embodiment is described here, while the second and third embodiments of map determination are described below with reference to FIG. 3B.

In a first embodiment of map determination, the reduced local map is based mainly on the global map, [symbol] . The server uses the information available to compute the reduced map, [symbol] , which contains the vertex that represents the mobile device's location at the time of request. The reduced map is computed in one of the following ways, depending on the amount of information gathered. Note that the size of the reduced map is here denoted to be calculated dependent on time, i.e., N_{E,red}(j). This time varying aspect comes from the second embodiment of map determination mentioned below, related to the interval statistic. However, if the second embodiment of map determination is not included, we simply have N_{E,red}(j)=N_{L,red} for all j≥0, i.e. not dependent on time.

The server uses its global map to calculate a reduced local map of size N_{red}(j) To calculate a reduced map, the server may use a marginalization technique, where the marginalization can be executed in several ways. For example, the marginalization can be done in a temporal manner, which marginalizes all measurements except the last N_{y} measurements. Another approach is spatial marginalization where all measurements except the N_{y} measurements that are spatially closest to the current position of the mobile device are marginalized. The marginalized parts (vertices and connected edges) of the map are thus excluded from the reduced local map.

In a send reduced local map step 56, the server 3 sends (to the mobile device 2) the determined reduced local map 32.

In a receive reduced local map step 48, the mobile device 2 receives (from the server 3) the reduced local map 32. In one embodiment, the mobile device replaces the graph in the mobile SLAM back-end 12a representing the local map with the reduced map, i.e. [symbol] purging the preceding local map.

Once the mobile device has received a new reduced map, the mobile device resets the duration statistic. This is performed since the duration statistic would otherwise take the last l−1 execution times with a preceding (now purged) large map into account, which might skew the statistic of the execution time to a larger value and trigger another map reduction request although the map size was recently reduced. For example, if a moving average is used as a statistic, the mobile device may set the l−1 previous execution time values to zero once it has received the reduced map and determined the execution time of the GO with the new reduced map.

Looking now to FIG. 3B, in the interest of conciseness, only new of modified steps compared to FIG. 3A will be described.

In an optional determine request time interval step 52, the server 3 determines a request time interval between consecutively received requests 30 for a reduced local map, received from the same mobile device 2.

The request time interval can be determined based on calculating a time interval statistic based on the most recent request time interval as well as at least one previously determined request time interval.

In this case, the reduced local map for the mobile device 2 is also determined in step 54 based on the request time interval.

This request time interval provides the server with the capability to infer computational load on the mobile device. This can used to adjust the size of the reduced map to the current status of the mobile device.

More specifically, in this second embodiment of map determination, the server loads its global map, [symbol] , optionally measures its own current CPU load L, and determines the time interval statistic, ΔT̅_{req}(j), of the time difference between requests from the mobile device over the last r+1 requests, i.e., ΔT̅_{req}(j)=h(ΔT_{req}(j), ΔT_{req}(j−1), . . . , ΔT_{req}(j−r+1), where h(⋅) is a function determining the time interval statistic, ΔT_{req}(i)=T_{req}(i)−T_{req}(i−1) is the time between the ith and the i−1th request. An example of this time interval statistic is a moving average filter as the one proposed for GO times above.

The server uses its global map, the time interval statistic of the time difference between reduced map requests ΔT̅_{req}(j), and thresholds, ΔTₘᵢₙ and ΔTₘₐₓ, for the time interval statistic of the time difference between requests. The server can compute the reduced map according to the following.

In one option, the reduced local map is determined to be smaller than a previous reduced local map when the time interval statistic is smaller than a first threshold ΔTₘᵢₙ. In other words, if ΔT̅_{req}(j)≤ΔTₘᵢₙ, the server will decrease the size, N_{red}(j), of the reduced map to be computed. For example, the map size may be reduced as follows N_{red}(j)=┌x_{d}N_{red}(j−1)┐, where x_{d}∈(0,1). If we would choose x_{d}=0.95 the map size would be less than half of the original value after 14 consecutive size reductions.

In one embodiment, the reduced local map is determined to be larger than a previous reduced local map when the time interval statistic is greater than a second threshold ΔTₘₐₓ. In other words, if ΔT̅_{req}(j)≥ΔTₘₐₓ, the server will increase the size, N_{red}(j), of the reduced map to be computed. For example, the map size may be increase as follows N_{red}(j)=┌xᵢN_{red}(i−1)┐, where xᵢ>1. If we would choose xᵢ=1.05 the map size would be more than twice the original value after 15 consecutive size increases.

If ΔTₘᵢₙ<ΔT̅_{req}(j)<ΔTₘₐₓ, the server does not change the size of the reduced map, i.e., N_{red}(j)=N_{red}(j−1).

Once the server has determined the reduced map size, the map determination can occur using any other embodiment presented herein.

An effect of this embodiment is that it uses the difference between request arrival times to draw conclusions on the mobile device load. If the server receives too many requests for a reduced map from the mobile device (i.e. small-time interval statistic), this indicates that the mobile device is struggling to perform GO shortly after it has added more measurements to the received reduced map. Therefore, the server will use ΔTₘᵢₙ to determine when the mobile device is struggling with the current size of the reduced map. Note that the function used to reduce the map size can have a lower limit, such that N_{red}(j)≥Nₘᵢₙ holds for all j≥0, where Nₘᵢₙ≥1 is a lower bound for the size of the reduced map. Similarly, if the time between requests grows too large, this indicates that the mobile device can handle larger map sizes in case the size of the reduced map has been reduced before. Therefore, the server increases the size of the reduced map. However, the size of the reduced map should be upper bounded such that N_{red}(j)≤N_{L,red} holds for all j≥0, where we recall that N_{L,red} is a fixed size for the reduced map that ensured a certain performance on the mobile device under benign conditions.

In one embodiment, the server extends the second embodiment of map determination with a mechanism to take over the graph optimization completely and stream pose information directly to the mobile device. For that, the server, in addition to the information from the second embodiment, uses the network conditions, C, such as the delay in the network, a threshold Cₘₐₓ for the delay, and a threshold, N_{L,min}≥Nₘᵢₙ≥1, for the size of the reduced map. Then the server computes the reduced map as follows:

If C≤Cₘₐₓ and N_{red}(j)≤Nₘᵢₙ, then the server will request the mobile device to stop executing the GO and the server will stream pose data directly to the mobile device, while the mobile device continues to send measurements to the server. In this embodiment, the server uses a lower bound on the size of the reduced map to determine when the mobile device is struggling with any size of a reduced map. If the reduced map size is decreased too much, this indicates that even though the size of the reduced map is getting smaller and smaller, the mobile device still has high execution times of the GO. Hence, the server can take over the GO, assuming the network conditions are good, and stream pose data directly to the mobile device. This alleviates the computational load of the mobile device such that it can allocate more CPU power to the other demanding tasks.

In an optional determine candidate local maps step 53, the server 3 determines a plurality of candidate local maps. In this case, the reduced local map for the mobile device 2 is also determined in step 54 in a third embodiment of map determination based on selecting a map, from the plurality of candidate local maps, that is the sparsest candidate local map.

In this embodiment, the server uses its global map, its current CPU load L and a threshold HIGH for the CPU load L to distinguish between high and low load scenarios.

If L<HIGH, the server uses its free CPU resources to compute at least two reduced maps, [symbol] of size N_{red}(j), where each reduced map [symbol] is determined with a different method indicate by the subscript i and we have I≥2 different options. For example, the server could use two cores to parallelize the computation of a reduced map, which is determined via spatial marginalization, and a reduced map, which is determined via temporal marginalization. Since the sparsity of the map also influences the computational time on the mobile device, the server then compares all reduced maps with respect to their sparsity and chooses the sparsest of the reduced maps, i.e., [symbol] =sparsestᵢ [symbol] To determine the sparsity of the maps, the server may use heuristics such as the graph density, the ratio of non-zero elements to zero elements in the graph's adjacency matrix, or the graph's maximum degree. The option, i*=arg sparsestᵢ [symbol] that results in the sparsest reduced map is then stored and provided to the mobile device 2.

If L≥HIGH, implying that the server has only limited resources available, the server then calculates only one reduced map of size N_{E,red}(j)=N_{D,red} and uses the option i* that was used in the (most recently) previously to determine the reduced map. If there was no previous option used, i.e., i*=0, the server will use a pre-determined default method to determine the reduced map such as, for example, temporal marginalization.

This embodiment exploits the fact that the execution time of the GO also depends on the graph sparsity and not only on the map size N_{red}(j). Hence, by using free CPU resources on the server 3 to determine the sparsest reduced map out of several reduced maps of size N_{red}(j) the execution time of the GO is expected to be even lower. Hence, computational load on the mobile device is reduced since the execution time of the graph optimization on the mobile device is reduced through the choice of sparsest reduced map among several options by the server.

In an optional merge local map step 49, the mobile device 2 merges the reduced local map 32 with at least one measurement collected after the sending 46 the request to the server. Hence mobile device and the mobile device incorporates [symbol] into its local map [symbol] In this case, the mobile device has taken more measurements of the environment while the server computed the reduced map. Once the reduced map is received by the mobile device, the mobile device merges the reduced map and the new measurements into a new local map as [symbol] where m(⋅) is a function that can merge two maps and [symbol] is a map that contains only the new measurements taken after the request for a reduced map. Since the reduced map contains the vertex that represented the mobile device's location at the time of the reduced map request, the merging of the maps is relatively straight-forward.

Using the embodiments presented herein, network load is reduced due to the event-triggered map requests by the mobile device, compared to e.g. periodic provision of reduced local maps from the server to the mobile device. Moreover, the computational load on the server is reduced, compared to periodic provision of reduced local maps, since the server only computes the reduced map when necessary.

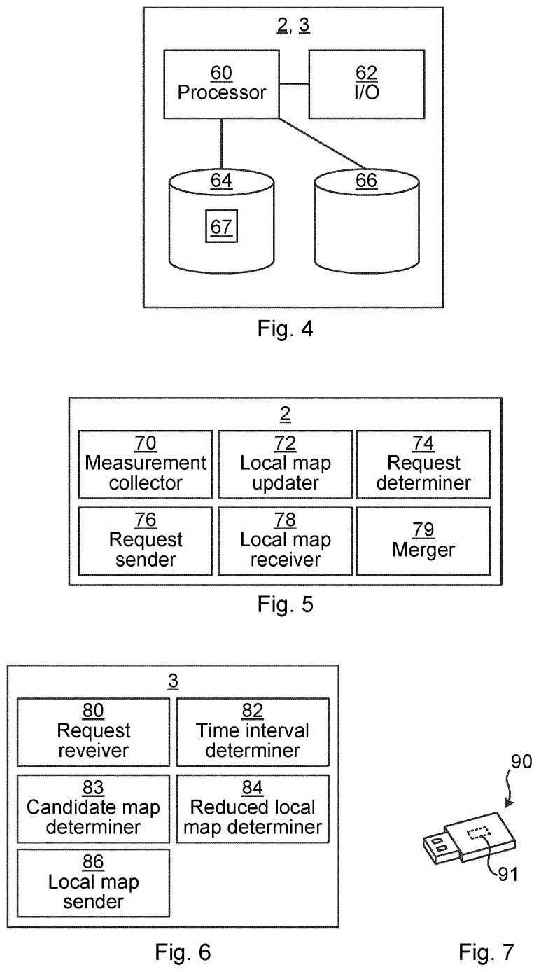

FIG. 4 is a schematic diagram illustrating components of the mobile device 2 and the server 3 of FIG. 1 and FIG. 2 according to one embodiment. A processor 60 is provided using any combination of one or more of a suitable central processing unit (CPU), graphics processing unit (GPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIGS. 3A-B above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

An I/O interface 62 is provided for communicating with external and/or internal entities using wired communication, e.g. based on Ethernet, and/or wireless communication, e.g. Wi-Fi, and/or a cellular network, complying with any one or a combination of sixth generation (6G) mobile networks, next generation mobile networks (fifth generation, 5G), LTE (Long Term Evolution), UMTS (Universal Mobile Telecommunications System) utilising W-CDMA (Wideband Code Division Multiplex), or any other current or future wireless network, as long as the principles described hereinafter are applicable.

Other components of the mobile device 2 and the server 3 are omitted in order not to obscure the concepts presented herein.

FIG. 5 is a schematic diagram showing functional modules of the mobile device 2 of FIG. 1 according to one embodiment. The modules are implemented using software instructions such as a computer program executing in the mobile device 2. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 3A and 3B.

A measurement collector 70 corresponds to step 40. A local map updater 72 corresponds to step 42. A request determiner 74 corresponds to step 44. A request sender 76 corresponds to step 46. A local map receiver 78 corresponds to step 48. A merger 79 corresponds to step 49.

FIG. 6 is a schematic diagram showing functional modules of the server 3 of FIG. 1 according to one embodiment. The modules are implemented using software instructions such as a computer program executing in the server 3. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 3A and 3B.

A request receiver 80 corresponds to step 50. A time interval determiner 82 corresponds to step 52. A candidate map determiner 83 corresponds to step 42. A reduced local map determiner 84 corresponds to step 54. A local map sender 86 corresponds to step 56.

FIG. 7 shows one example of a computer program product 90 comprising computer readable means 91. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 4. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. (canceled)

2. A method for updating a map for simultaneous localization and mapping (SLAM), the method being performed by a mobile device comprising at least one sensor, the method comprising:
collecting measurements from the at least one sensor;
updating a local map based on the measurements, wherein the local map is in the form of a graph comprising vertices and edges;
determining, based on a duration of performing the updating of the local map, that a reduced local map is to be requested;
sending, to a server, a request for a reduced local map; and
receiving, from the server, a reduced local map.

3. The method of claim 2, wherein the determining that the reduced local map is to be requested comprises calculating a duration statistic based on the most recent duration, as well as previously determined durations, of performing the updating of the local map, and determining that the duration statistic is greater than a threshold.

4-7. (canceled)

8. A mobile device for updating a map for simultaneous localization and mapping (SLAM), the mobile device comprising:
at least one sensor;
a processor; and
a memory storing instructions that, when executed by the processor, cause the mobile device to:
collect measurements from the at least one sensor;
update a local map based on the measurements, wherein the local map is in the form of a graph comprising vertices and edges;
determine, based on a duration of performing the updating of the local map, that a reduced local map is to be requested;
send, to a server, a request for a reduced local map; and
receive, from the server, a reduced local map.

9. The mobile device of claim 8, wherein the instructions to determine that the reduced local map is to be requested comprise instructions that, when executed by the processor, cause the mobile device to calculate a duration statistic based on the most recent duration, as well as previously determined durations, of performing the updating of the local map, and determining that the duration statistic is greater than a threshold.

10. The mobile device of claim 9, wherein the duration statistic is based on at least one of a moving average filter, and a moving median filter.

11. The mobile device of claim 8, further comprising instructions that, when executed by the processor, cause the mobile device to merge the reduced local map with at least one measurement collected after the instructions to send the request to the server are performed.

12. The mobile device of claim 8, wherein the measurements are based on at least one of inertial measurements, LIDAR measurements, two-dimensional images, three-dimensional images and radar measurements.

13. The mobile device of claim 8, wherein each vertex represents a pose or a feature.

14. A non-transitory computer readable storage medium storing a computer program for configuring a mobile device to perform the method of claim 2.

15. (canceled)

16. A method for updating a map for simultaneous localization and mapping (SLAM), the method being performed by a server, the method comprising:
receiving, from a mobile device, a request for a reduced local map;
determining a reduced local map for the mobile device being a subset of a global map, wherein both the global map and the reduced local map are in the form of a graph comprising vertices and edges; and
sending, to the mobile device, the determined reduced local map.

17-23. (canceled)

24. A server for updating a map for simultaneous localization and mapping, SLAM, the server comprising:
a processor; and
a memory storing instructions that, when executed by the processor, cause the server to:
receive, from a mobile device, a request for a reduced local map;
determine a reduced local map for the mobile device being a subset of a global map, wherein both the global map and the reduced local map are in the form of a graph comprising vertices and edges; and
send, to the mobile device, the determined reduced local map.

25. The server of claim 24, further comprising instructions that, when executed by the processor, cause the server to:
determine a request time interval between consecutively received requests for a reduced local map;
wherein the instructions to determine the reduced local map for the mobile device comprises instructions that, when executed by the processor, cause the server to determine the reduced local map also based on the request time interval.

26. The server of claim 25, wherein the instructions to determine a request time interval comprise instructions that, when executed by the processor, cause the server to calculate a time interval statistic based on the most recent request time interval as well as at least one previously determined request time interval.

27. The server of claim 26, wherein the instructions to determine a reduced local map comprise instructions that, when executed by the processor, cause the server to determine a reduced local map that is smaller than a previous reduced local map when the time interval statistic is smaller than a first threshold.

28. The server of claim 26, wherein the instructions to determine a reduced local map comprise instructions that, when executed by the processor, cause the server to determine a reduced local map that is larger than a previous reduced local map when the time interval statistic is greater than a second threshold.

29. The server of claim 24, further comprising instructions that, when executed by the processor, cause the server to execute, prior to the instructions to determine a reduced local map:
determine a plurality of candidate local maps;
wherein the instructions to determine the reduced local map for the mobile device comprises instructions that, when executed by the processor, cause the server to select a map, from the plurality of candidate local maps, that is the sparsest candidate local map.

30. The server of claim 29, further comprising instructions that, when executed by the processor, cause the server to execute the instructions to determine a plurality of candidate local maps is only if a resource utilisation of the server is less than a utilisation threshold.

31. The server of claim 24, wherein each vertex represents a pose or a feature.

32. A non-transitory computer readable storage medium storing a computer program for configuring a server to perform the method of claim 16.

33. (canceled)
